(19) United States
(12) Patent Application Publication
(10) Pub. No.: US 2012/0293817 A1
(43) Pub. Date: Nov. 22, 2012

(54) FAILING NOZZLE DETECTING APPARATUS, PRINTING APPARATUS, FAILING NOZZLE DETECTING METHOD, AND MEDIUM RECORDING COMPUTER PROGRAM

(75) Inventor: Tsuneo Kasai, Azumino-shi (JP)

(73) Assignee: SEIKO EPSON CORPORATION, Tokyo (JP)

(21) Appl. No.: 13/472,791

(22) Filed: May 16, 2012

(30) Foreign Application Priority Data
May 17, 2011 (JP) 2011-110205

(51) Int. Cl. G06K 15/02

(52) U.S. Cl. 358/1.13

(57) ABSTRACT

A failing nozzle detecting apparatus includes a reference image generating unit that generates plural pieces of reference image data with pixel positions along a transporting direction respectively shifted by different offsets based on image data, and a scanning unit that scans an image on the print medium relatively transported by the transporting unit to generate scanned image data. The failing nozzle detecting apparatus selects reference image data to be used in comparison with the scanned image data from the plural pieces of reference image data. The failing nozzle detecting apparatus detects a failing nozzle from the plurality of nozzles based on the comparison of the scanned image data with the selected reference image data.

### CROSS REFERENCES TO RELATED APPLICATIONS

The present invention contains subject matter related to Japanese Patent Application No. 2011-110205 filed in the Japanese Patent Office on May 17, 2011, the entire contents of which are incorporated herein by reference.

### BACKGROUND

1. Technical Field

The present invention relates to a technique of detecting a failing nozzle in a printing apparatus.

2. Related Art

When some ink ejecting nozzles mounted in a printing head of an ink jet type printing apparatus fail, a streak of bad printing may appear on a print medium. According to a technique described in JP-A-2010-240911, for example, a print medium having an image printed thereon is scanned while transporting the print medium in a predetermined direction, and the scanned result is compared with a reference image to detect a failing nozzle. In a case of scanning an image while transporting the print medium, however, when there is an error in the amount of transportation of the print medium by a transporting mechanism due to some factor, the comparison with the reference image may not be carried out accurately, thus lowering the accuracy of detecting a failing nozzle.

JP-A-2010-173289 is also an example of related art.

### SUMMARY

An advantage of some aspects of the invention is to provide a technique of accurately detecting a failing nozzle even when the amount of transportation of a print medium is deviated due to some factor.

To achieve at least part of the advantage, the invention may be achieved in the following modes or as the following application examples.

### Application Example 1

A failing nozzle detecting apparatus for detecting a failing nozzle based on a print medium on which an image represented by image data is printed with a printing head having a plurality of nozzles, and which is relatively transported in a transporting direction by a transporting unit, the apparatus including a reference image generating unit that generates plural pieces of reference image data with pixel positions along the transporting direction respectively shifted by different offsets based on the image data; a scanning unit that scans an image on the print medium relatively transported by the transporting unit to generate scanned image data; a selecting unit that selects reference image data to be used in comparison with the scanned image data from the plural pieces of reference image data; and a detecting unit that detects a failing nozzle from the plurality of nozzles based on the comparison of the scanned image data with the selected reference image data.

According to this configuration, plural pieces of reference image data with different pixel positions along the transporting direction are generated, reference image data to be compared with the scanned image data is selected from those pieces of reference image data, and the selected reference image data is compared with the scanned image data to detect a failing nozzle. Even when the amount of transportation of the print medium is deviated due to some factor, therefore, a failing nozzle can be detected accurately.

### Application Example 2

In the failing nozzle detecting apparatus according to the Application Example 1, the reference image generating unit generates the plural pieces of reference image data using an offset position corresponding to the reference image data selected by the selecting unit as a reference position.

According to this configuration, plural pieces of reference image data are generated based on an offset position corresponding to reference image data once selected, so that reference image data which ensures adequate comparison with scanned image data can be generated. Further, the generation of reference image data which ensures adequate comparison with scanned image data can reduce the quantity of reference image data to be generated.

### Application Example 3

In the failing nozzle detecting apparatus according to the Application Example 1 or the Application Example 2, a quantity of the reference image data generated by the reference image generating unit is set based on an expected amount of transporting deviation of the print medium.

According to this configuration, when the expected amount of transporting deviation of a print medium is small, the quantity of reference image data to be generated can be reduced accordingly.

### Application Example 4

In the failing nozzle detecting apparatus according to any one of the Application Examples 1 to 3, the reference image generating unit generates the plural pieces of reference image data by stepwisely shifting each of pixel positions of the plural pieces of reference image data in the transporting direction by an amount equal to or less than double the amount of transporting deviation allowable in the comparison in the detecting unit.

According to this configuration, plural pieces of reference image data with their pixel positions shifted stepwisely by an amount equal to or less than double the amount of transporting deviation allowable in the comparison in the detecting unit are generated, so that regardless of whether the scanned image data and reference image data are shifted in the forward direction or the opposite direction along the transporting direction, both image data can be adequately compared with each other.

The invention may be achieved as a failing nozzle detecting apparatus including a transporting unit, a printing apparatus including a printing head and a failing nozzle detecting apparatus, a failing nozzle detecting method, and a computer program in addition to the aforementioned failing nozzle detecting apparatuses. The computer program may be recorded on a computer readable recording medium. Available examples of the recording medium include a flexible disk, CD-ROM, DVD-ROM, magneto-optical disc, memory card, and hard disk.

### BRIEF DESCRIPTION OF THE DRAWINGS

The invention will be described with reference to the accompanying drawings, wherein like numbers reference like elements.

FIG. 1 is an explanatory diagram illustrating the schematic configuration of a printing apparatus as an exemplary embodiment of the invention.

FIG. 2 is an explanatory diagram exemplifying the layout of ink ejecting nozzles.

FIG. 3 is an explanatory diagram showing the scanning resolution of a scanning unit.

FIG. 4 is an explanatory diagram showing various examples of the scanning resolution.

FIGS. 5A to 5C are explanatory diagrams illustrating the principle of detection of bad printing.

FIGS. 6A to 6E are explanatory diagrams showing calculated values of a positional difference when transportation of a print medium is delayed.

FIGS. 7A and 7B are explanatory diagrams showing examples of plural pieces of reference image data.

FIG. 8 is a flowchart of a failing nozzle detecting routine.

FIG. 9 is a diagram showing an example where a transporting roller is eccentric.

### DESCRIPTION OF EXEMPLARY EMBODIMENTS

### A. Configuration of Apparatus

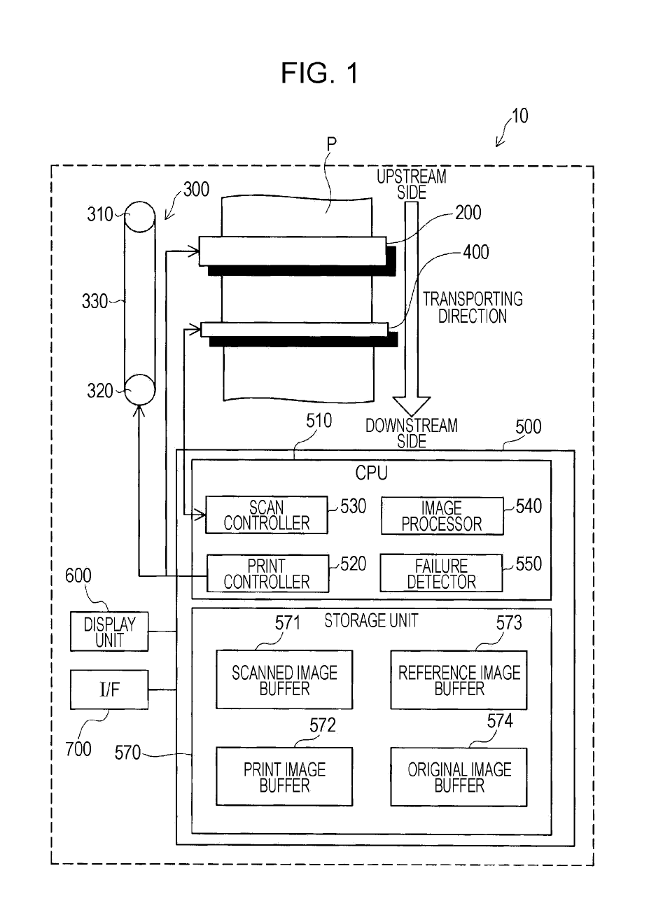

FIG. 1 is an explanatory diagram illustrating the schematic configuration of a printing apparatus 10 as an exemplary embodiment of the invention. The printing apparatus 10 according to the embodiment is an ink jet type color printer, and includes a head unit 200, a transporting unit 300, a scanning unit 400, a control unit 500, a display unit 600, and an interface 700. The printing apparatus 10 acquires image data from a computer or the like connected to the interface 700, and ejects ink droplets from the head unit 200 onto a print medium P which is transported by the transporting unit 300 to print an image on the print medium P. The printing apparatus 10 also has a capability of scanning an image printed on the print medium P (hereinafter simply referred to as “printed image”) with the scanning unit 400. The printing apparatus 10 is equivalent to the “failing nozzle detecting apparatus” according to the invention.

The head unit 200 includes an ejecting head including ink ejecting nozzles for ink of each color, namely, black (K), cyan (C), magenta (M) or yellow (Y). The ejecting head ejects inks from the ink ejecting nozzles by controlling the voltages of unillustrated piezoelectric elements. According to the embodiment, the printing apparatus 10 makes printing with four color inks, but may differ from the foregoing type in the types of colors in use or the number of colors in use.

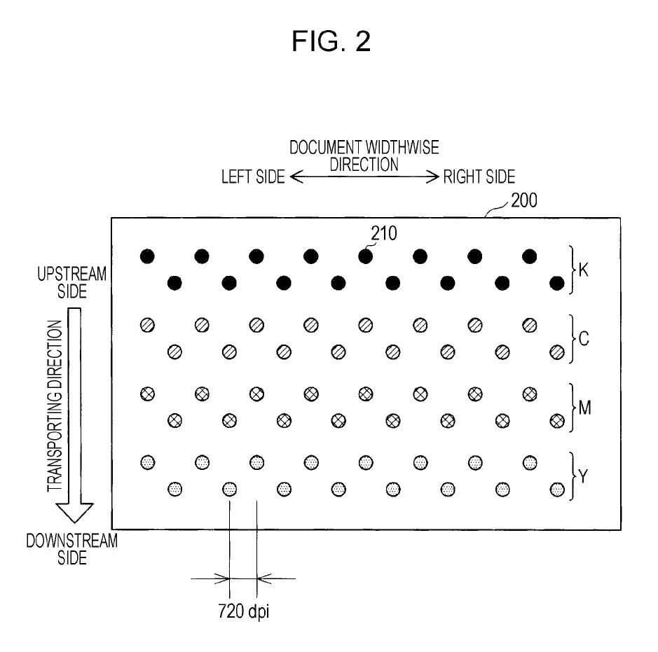

FIG. 2 is an explanatory diagram exemplifying the layout of ink ejecting nozzles 210. The head unit 200 includes a plurality of ejecting nozzles 210 on its side (bottom side) facing the print medium P. The ejecting nozzles 210 of the individual colors are disposed on the bottom side of the head unit 200 along the direction of the print medium P to be transported by the transporting unit 300. The ejecting nozzles 210 of the individual colors are aligned for each of black (K), cyan (C), magenta (M) and yellow (Y) in a zigzag pattern in a direction orthogonal to the transporting direction (hereinafter referred to as “document widthwise direction”). Each of the ejecting nozzles 210 of each color aligned in a zigzag pattern is configured to have its width equal to the printable area of the print medium P. That is, the printing apparatus 10 according to the embodiment is configured as what is called a line printer. The ejecting nozzles 210 of each color are disposed so as to be able to eject ink droplets at a predetermined printing resolution (e.g., 720 dpi).

The transporting unit 300 (see FIG. 1) includes transporting rollers 310, 320, and a transporting belt 330 stretched over the transporting rollers 310, 320. The transporting unit 300 drives the transporting belt 330 by means of an unillustrated drive motor to transport the print medium P on the transporting belt 330 downstream from the upstream side of the transporting direction. The transporting speed of the transporting unit 300 is controlled so that dots of a predetermined printing resolution (e.g., 1440 dpi) are formed in the transporting direction with ink ejected by the head unit 200.

The scanning unit 400 is disposed downstream of the head unit 200 in the transporting direction. The scanning unit 400 scans a printed image on the print medium P which is transported by the transporting unit 300. The scanning unit 400 includes an image sensor and a light source both unillustrated. A CCD image sensor or a CMOS image sensor, for example, may be used as the image sensor. A white LED or a white CCFL (Cold-Cathode Fluorescent Lamp), for example, may be used as the light source.

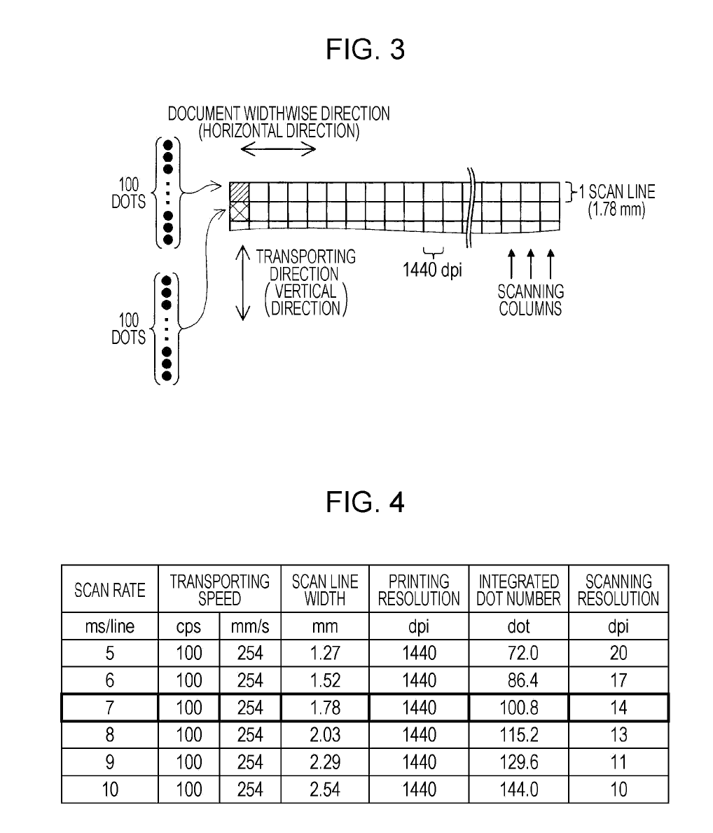

FIG. 3 is an explanatory diagram showing the scanning resolution of the scanning unit 400. FIG. 4 is an explanatory diagram showing various examples of the scanning resolution. According to the embodiment, as shown in FIG. 3, the scanning unit 400 scans a printed image in the transporting direction of the print medium at a resolution (10 to 20 dpi) lower than the resolution of the printed image (1440 dpi). When the transporting speed of the print medium P is 254 mm/sec and the time (scan rate) needed for one scanning in the document widthwise direction is 7 ms, for example, the print medium P is transported by 1.78 mm while the scanning unit 400 scans the image, as shown in FIG. 4. In other words, one line at time of scanning (one scan line) is a width equivalent to 1.78 mm. When the printing resolution in the transporting direction is 1440 dpi, for example, the width of 1.78 mm is equivalent to a width of 100 dots of the printed image, and the scanning resolution is 14 dpi as shown in FIG. 3. When one line of an image is scanned by the scanning unit 400, therefore, the image becomes an image with the resolution in the transporting direction compressed to 1/100, and its pixel value becomes an average value of pixel values of 100 dots of the printed image in the transporting direction. Although image scanning is carried out at the transporting speed of the print medium P of 254 mm/sec and the scan rate of 7 ms according to the embodiment, other values may be used as needed.

According to the embodiment, as mentioned above, the scanning resolution in the transporting direction is set lower than the printing resolution of a printed image, but the scanning resolution in the document widthwise direction is set higher than the printing resolution of the printed image. When the printing resolution in the document widthwise direction is 720 dpi, for example, scanning is carried out at a resolution equal to or higher than double the printing resolution (1440 dpi) as shown in FIG. 3. Scanning at a high resolution in the document widthwise direction this way can ensure accurate detection of a streak of bad printing. The direction corresponding to the transporting direction of a printed image or a scanned image is also referred to as “vertical direction”, and the direction corresponding to the document widthwise direction is also referred to as “horizontal direction” hereinafter. Further, each position of a scanned image in the horizontal direction is referred to as “scanning column”. A scanning column corresponds to the position of each ejecting nozzle 210 of the head unit 200. Specifically, provided that the resolution of the ejecting nozzles 210 in the document widthwise direction is 720 dpi and the horizontal resolution of each scanning column is 1440 dpi, adjoining two scanning columns correspond to a single nozzle.

The control unit 500 (see FIG. 2) includes a CPU 510 and a storage unit 570, and controls the general operation of the printing apparatus 10. The CPU 510 executes a control program (not shown) stored in the storage unit 570 to function as a print controller 520 which controls driving of the head unit 200 and the transporting unit 300, a scan controller 530 which controls the scanning unit 400, an image processor 540, and a failure detector 550. The storage unit 570 includes a scanned image buffer 571, a print image buffer 572, a reference image buffer 573, and an original image buffer 574. The failure detector 550 is equivalent to the “reference image generating unit”, “selecting unit” and “detecting unit” according to the invention.

The image processor 540 acquires image data (hereinafter referred to as “original image data”) from a computer or the like connected to the interface 700, and stores the image data into the original image buffer 574. The image processor 540 then subjects the original image data to a color converting process of converting an RGB value to a CMYK value, a half-tone process or the like to generate data for forming an image on a print medium P (hereinafter referred to as “print image data”). The image processor 540 stores the print image data into the print image buffer 572 in the storage unit 570.

The print controller 520 controls the head unit 200 to print an image based on the print image data stored in the print image buffer 572 while controlling the transporting unit 300 to transport the print medium P downstream.

The scan controller 530 controls the scanning unit 400 to scan the printed image on the print medium P, which is transported from the upstream side, for each scan line. The scan controller 530 stores the scanned image as scanned image data into the scanned image buffer 571 in the storage unit 570.

The failure detector 550 detects a failing nozzle based on the scanned image data stored in the scanned image buffer 571 and plural pieces of reference image data which are prepared by a method to be discussed later. In generating plural pieces of reference image data, the failure detector 550 performs a resolution converting process on the original image data to match the resolution of each piece of reference image data with the resolution of the scanned image data.

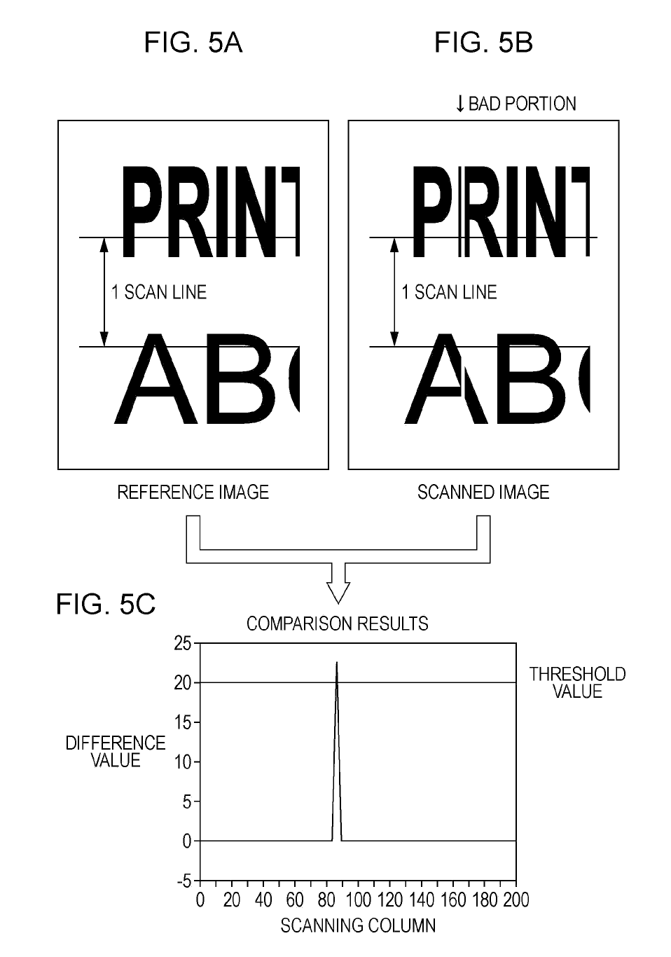

FIGS. 5A to 5C are explanatory diagrams illustrating the principle of detection of bad printing.

FIG. 5A shows a part of a reference image, and FIG. 5B shows a part of a scanned image. The range that is indicated in FIGS. 5A and 5B by “1 scan line” specifies the range to be scanned in single scanning by the scanning unit 400. Therefore, the vertical resolution of an image within this range is actually compressed to 1/100 to average the pixel values.

A streaking bad printing portion appears on the scanned image shown in FIG. 5B. As a result, calculating the difference in pixel value between the reference image shown in FIG. 5A and the scanned image shown in FIG. 5B makes a difference value between the scanning columns corresponding to the streaking bad printing portion larger as shown in FIG. 5C. Therefore, the positions of scanning columns where bad printing has occurred, i.e., the position of a failing nozzle can be detected by comparing the difference value with a predetermined threshold value.

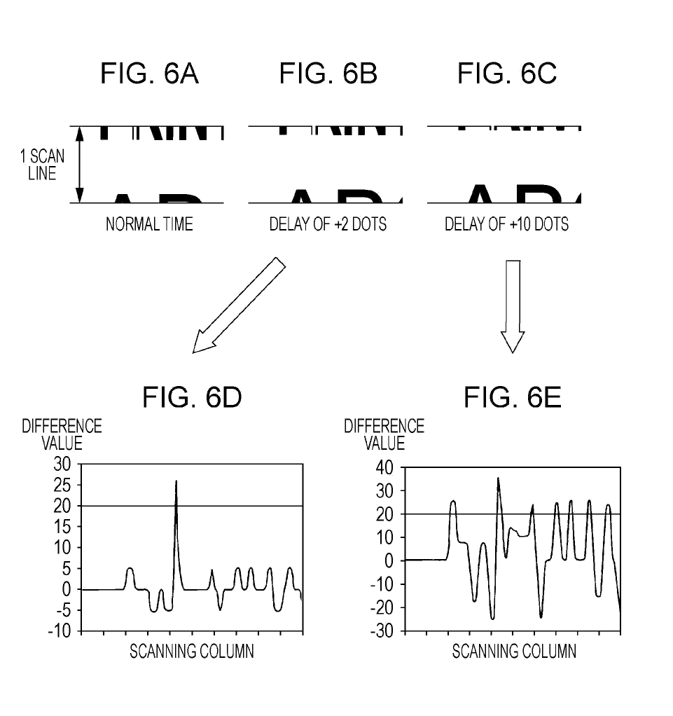

FIGS. 6A to 6E are explanatory diagrams showing calculated values of a positional difference when the amount of transportation of the print medium P is delayed. When transportation of the print medium P is delayed until the print medium P is transported to the scanning unit 400 after printing with the head unit 200 due to some factor, a positional deviation occurs on the scanned image as shown in FIGS. 6B and 6C. FIG. 6A shows a scanned image when there is not any delay in the transportation of the print medium P, and FIG. 6B shows a scanned image when there is a delay of two dots in the transportation of the print medium P. FIG. 6C shows a scanned image when there is a delay of ten dots in the transportation of the print medium P. “Two dots” and “ten dots” indicate the numbers of dots in different printing resolutions.

FIG. 6D shows the difference between the scanned image shown in FIG. 6B and the reference image shown in FIG. 5A. As apparent from FIG. 6D, a transportation deviation of two dots or so in the printing resolution does not cause a significant variation in the difference value, so that the position of a failing nozzle can be detected by setting an adequate threshold value. When there is a transportation deviation of ten dots or so in the printing resolution as shown in FIG. 6C, by comparison, difference values at other portions than the bad printing portion become greater as shown in FIG. 6E. This makes it difficult to set an adequate threshold value, thus making it difficult to specify the presence or absence of a failing nozzle and the position of the failing nozzle.

In consideration of a deviation in the aforementioned amount of transportation of the print medium P, the failure detector 550 has generated plural pieces of reference image data different from one another in the vertical offset position from original image data, and has stored the reference image data in the reference image buffer 573 beforehand. Then, the failure detector 550 selects reference image data most approximate to scanned image data, and compares the selected reference image data with the scanned image data to detect a failing nozzle.

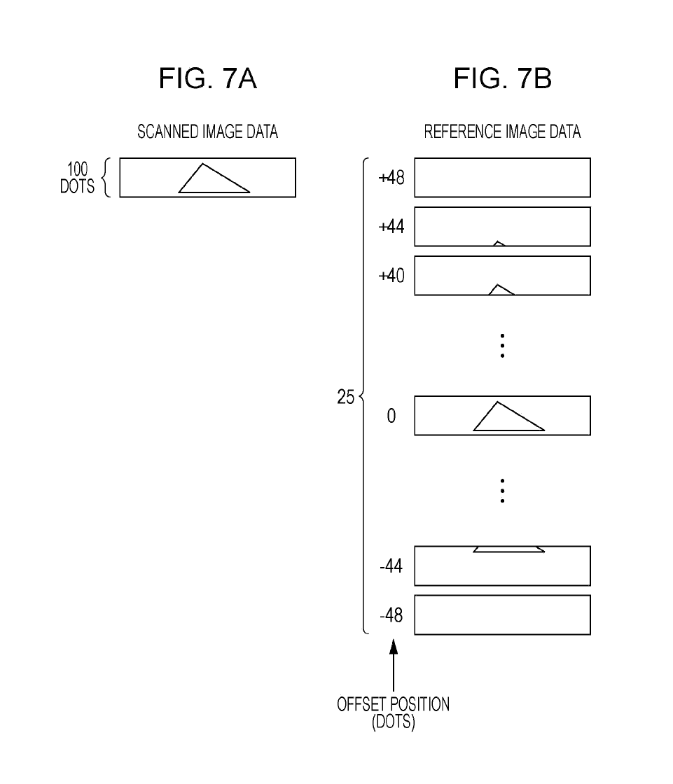

FIGS. 7A and 7B are explanatory diagrams showing examples of plural pieces of reference image data which are generated by the failure detector 550. If the allowable amount of deviation is ±2 dots as shown in FIG. 6B, plural pieces of reference image data with their pixel positions shifted stepwisely by four dots in the vertical direction are prepared. Accordingly, regardless of whether the scanned image data is shifted in the forward direction or the opposite direction along the transporting direction, deviations in the reference image data and the scanned image data can be suppressed to a maximum width of two dots. When the width of one scan line is 100 dots as shown in FIG. 7A, for example, the scanned image data and the reference image data can be adequately compared with each other, unless the scanning range is completely shifted, by previous preparation of 25 types of reference image data whose vertical image positions are shifted from one another by four dots as shown in FIG. 7B. Although FIGS. 7A and 7B show triangular figures in the images for ease of understanding, pixel values of 100 dots of scanned image data in the vertical direction are averaged, so that a figure does not appear on the scanned image data in a width of one scan line. In addition, resolution conversion is performed on reference image data according to scanned image data, pixel values of 100 dots of reference image data in the vertical direction are averaged as in the case of scanned image data. Therefore, a figure as shown in FIG. 7B does not appear on the reference image data in a width of one scan line. Although plural pieces of reference image data with their vertical pixel positions shifted by an amount (four dots) equal to double the allowable amount of deviation (two dots) according to the embodiment, the amount of deviation may be less than that amount (e.g., three dots) as long as the amount is equal to or less than double the allowable amount of deviation.

### B. Failing Nozzle Detecting Routine

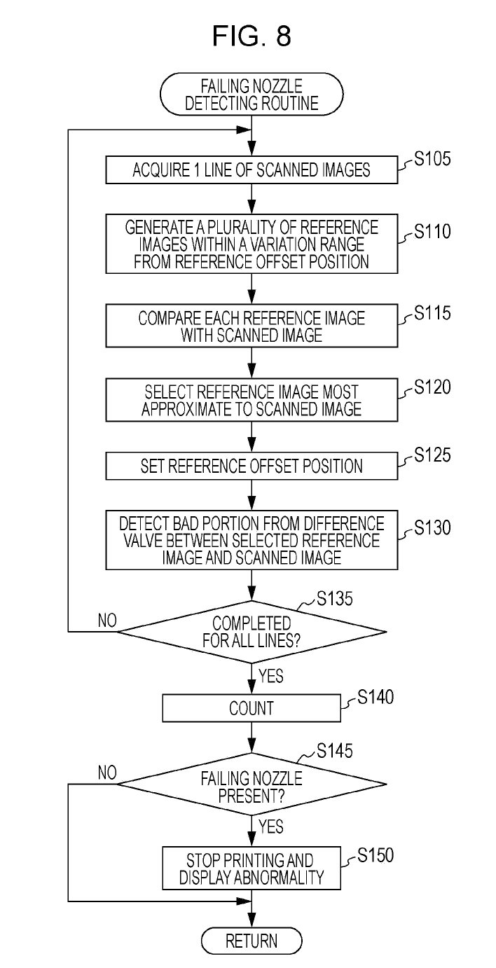

FIG. 8 is a flowchart of a failing nozzle detecting routine which is executed by the failure detector 550. This failing nozzle detecting routine is executed in parallel to printing of an image on a print medium P by the print controller 520.

When the failing nozzle detecting routine is executed, the failure detector 550 first acquires one line of scanned image data scanned by the scanning unit 400 from the scanned image buffer 571 (step S105).

After acquiring the scanned image data, the failure detector 550 generates plural pieces of reference image data included in an expected deviation range (hereinafter referred to as “variation range”) from an offset position to be a reference (hereinafter referred to as “reference offset position”) (step S110). The reference offset position represents a representative value of the offset positions of plural pieces of reference image data to be comparison with the scanned image data, and is initially “0” (see FIG. 7B). The variation range is a value indicating an expected deviation range, and can be set from −48 to +48 at a maximum in the example shown in FIG. 7B. When the reference offset position is “0” and the variation range is from −48 to +48, for example, the failure detector 550 generates a total of 25 pieces of reference image data with the offset positions stepwisely shifted by four dots both upward and downward in the vertical direction with the reference offset position being the center, as shown in FIG. 7B.

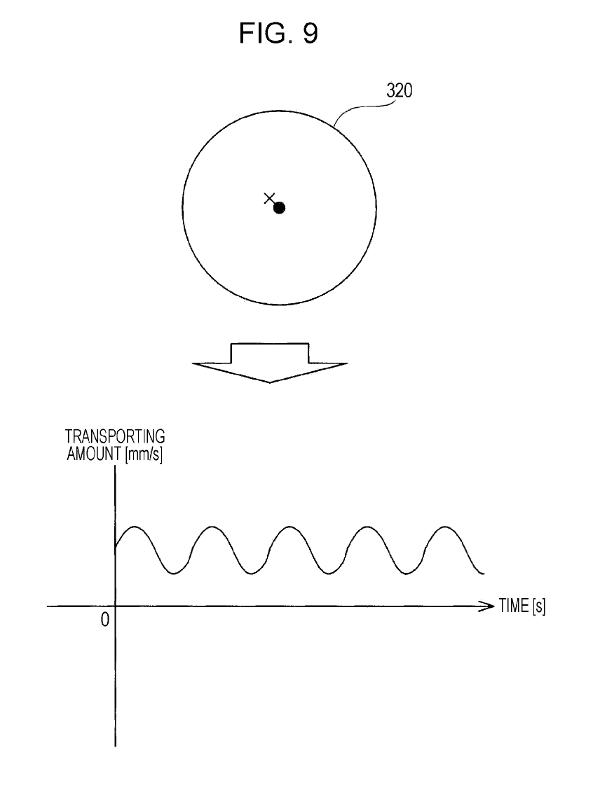

When the maximum value of the amount of transporting deviation is known previously, the variation range can be set according to the maximum value. Provided that the amount of transporting deviation varies within a predetermined range (e.g., ±0.5 mm) due to the eccentricity or deformation of the transporting roller 320, or an error in the circumferential length of the transporting roller 320 as shown in FIG. 9, the range of the offset positions (e.g., −28 to +28) equivalent to the predetermined range can be set as the variation range. When the variation range is set narrow this way, it is possible to reduce the number of pieces of reference image data to be generated. FIG. 9 shows the rotational center of the transporting roller 320 by mark “X” and the center of a circle by a bullet.

After generating plural pieces of reference image data within the variation range, the failure detector 550 compares each generated reference image data with the scanned image data (step S115), and selects reference image data most approximate to the scanned image data (step S120). Specifically, the failure detector 550 calculates the difference between the pixel value of each pixel in each reference image data with the pixel value of each pixel in the scanned image data, and sums up the absolute values of the differences for the entire image data. Then, the failure detector 550 selects the reference image data with the least sum as reference image data most approximate to the scanned image data.

Upon selection of the reference image data most approximate to the scanned image data, the failure detector 550 sets the offset position corresponding to the selected reference image data as the reference offset position, and stores it in the storage unit 570 (step S125). The reference offset position stored in this manner is referred to when the process of step S105 is executed next.

After setting the reference offset position, the failure detector 550 compares the scanned image data acquired in step S105 with the reference image data selected in step S115 to detect a bad portion in the scanned image data (step S130). Specifically, the failure detector 550 calculates the absolute value of the difference between the pixel value of the reference image data in each scanning column and the pixel value of the scanned image data in each scanning column, and detects a scanning column for which the absolute value of the difference exceeds a predetermined threshold value as a bad portion (see FIG. 5C). According to the embodiment, the threshold value to be comparison with the absolute value of the difference is set to a value which ensures determination of a bad portion even when the allowable amount of transporting deviation of the print medium P (±2 dots in the embodiment) (see FIG. 6D). This value can be set to “20” or so when the probable range of the absolute value of the difference is, for example, from “0” to “255”. Upon detection of a bad portion this way, the failure detector 550 stores the detected bad portion in the storage unit 570.

After detecting a bad portion in current scanned image data in the above manner, the failure detector 550 determines whether detection of a bad portion is completed for every scan line of the printed image (step S135). When detection of a bad portion for every scan line is not completed, the failure detector 550 returns to the process of step S105, and repeats the sequence of processes of steps S105 to S125 for a next scan line. When detection of a bad portion for every scan line is completed, on the other hand, the failure detector 550 counts the number of bad portions for the individual scanning columns of the scan lines (step S140).

When counting the number of bad portions, the failure detector 550 determines based on the count value whether there is a failing nozzle (step S145). Specifically, the failure detector 550 determines a nozzle corresponding to the scanning column for which the counted number of bad portions exceeds a predetermined threshold value as a failing nozzle. This threshold value can be set to about 10% of the total number of scan lines.

When determining that there is a failing nozzle, the failure detector 550 instructs the print controller 520 to stop printing. Then, the failure detector 550 displays the event of the detection of a failing nozzle and the position of the failing nozzle on the display unit 600 (step S150). A user who sees this display can perform various correction processes, such as cleaning the head or image processing for making a bad portion unnoticeable. When determining that there is no failing nozzle, on the other hand, the failure detector 550 terminates the failing nozzle detecting routine. Although printing is immediately stopped when it is determined that there is a failing nozzle according to the embodiment, the failure detector 550 may display the occurrence of a bad portion without stopping printing. The display location of the event of the detection of a failing nozzle and the position of the failing nozzle is not limited to the display unit 600, and may be the monitor of a computer connected to the interface 700.

The foregoing printing apparatus 10 according to the embodiment generates plural pieces of reference image data with different pixel positions along the transporting direction from original image data, and selects reference image data approximate to scanned image data from those pieces of reference image data. Then, the printing apparatus 10 compares the selected reference image data with the scanned image data to detect a failing nozzle. Even when the amount of transportation of a print medium P is deviated, therefore, a failing nozzle can be detected accurately.

Because scanning is carried out at a scanning resolution lower than the printing resolution according to the embodiment, the amount of scanned image data can be reduced. Further, because the scanning resolution in the transporting direction can be lowered, a failing nozzle can be detected using an image sensor with a comparatively low accuracy. This can lead to reduction in the manufacturing cost for the printing apparatus 10. Even when the scanning resolution in the transporting direction is lowered, bad printing caused by the presence of a failing nozzle almost occurs in the transporting direction of the print medium P. If the resolution in the document widthwise direction (horizontal direction) is secured, therefore, reduction in the accuracy of detecting a failing nozzle is suppressed.

Because detection of a failing nozzle is carried out in parallel to printing according to the embodiment, printing can be stopped immediately upon detection of a failing nozzle. In case where the printing apparatus 10 is designed for mass printing, for example, it is possible to suppress occurrence of a large amount of bad printing.

### C. Modifications

Although only one embodiment of the invention has been described herein, it should be apparent to those skilled in the art that the invention is not limited to such an embodiment and may take various configurations without departing from the spirit or scope of the invention. For example, the functions that are achieved by software may be achieved by hardware, and vice versa. In addition, the following modifications are feasible.

According to the foregoing embodiment, the “variation range” at the time of acquiring plural pieces of reference image data is set beforehand. However, the variation range may be limited to a range narrower than the initial range (e.g., half the initial variation range) once the reference offset position is set. This is because once the reference offset position is set, the reference offset position does not vary abruptly in a next scan line, and reference image data most approximate to scanned image data can be adequately selected even in the narrowly set range of reference image data. Therefore, the number of pieces of reference image data to be generated can be reduced by changing the reference offset position according to the offset position of the reference image data approximate to the scanned image data.

According to the foregoing embodiment, the scanning unit 400 scans an image from a print medium P which is transported by the transporting unit 300. However, the scanning unit 400 may move to scan an image from a fixed print medium P. That is, the print medium has only to move relative to the scanning unit 400.

Although the printing apparatus 10 is a line printer according to the foregoing embodiment, it may be a serial printer. Further, the printing apparatus 10 is not limited to an ink jet type, and may be of a laser type or a thermal transfer type.

Although a print medium P in use is a roll type print medium according to the foregoing embodiment, the print medium may be a sheet previously cut to size A4, size A3 or the like. In addition, the print medium is not limited to a sheet of paper, and may take various forms, such as a film type print medium and a print medium made of a resin.

What is claimed is:

1. A failing nozzle detecting apparatus for detecting a failing nozzle based on a print medium on which an image represented by image data is printed with a printing head having a plurality of nozzles, and which is relatively transported in a transporting direction by a transporting unit, the apparatus comprising:
a reference image generating unit that generates plural pieces of reference image data with pixel positions along the transporting direction respectively shifted by different offsets based on the image data;
a scanning unit that scans an image on the print medium relatively transported by the transporting unit to generate scanned image data;
a selecting unit that selects reference image data to be used in comparison with the scanned image data from the plural pieces of reference image data; and
a detecting unit that detects a failing nozzle from the plurality of nozzles based on the comparison of the scanned image data with the selected reference image data.

2. The failing nozzle detecting apparatus according to claim 1, wherein the reference image generating unit generates the plural pieces of reference image data using an offset position corresponding to the reference image data selected by the selecting unit as a reference position.

3. The failing nozzle detecting apparatus according to claim 1, wherein a quantity of the reference image data generated by the reference image generating unit is set based on an expected amount of transporting deviation of the print medium.

4. The failing nozzle detecting apparatus according to claim 1, wherein the reference image generating unit generates the plural pieces of reference image data by stepwisely shifting each of pixel positions of the plural pieces of reference image data in the transporting direction by an amount equal to or less than double the amount of transporting deviation allowable in the comparison in the detecting unit.

5. The failing nozzle detecting apparatus according to claim 1, comprising the transporting unit.

6. The failing nozzle detecting apparatus according to claim 1, comprising the printing head.

7. A failing nozzle detecting method to be executed by a failing nozzle detecting apparatus, comprising:
relatively transporting a print medium on which an image represented by image data is printed with a printing head having a plurality of nozzles in a transporting direction;
generating plural pieces of reference image data with pixel positions along the transporting direction respectively shifted by different offsets based on the image data;
scanning an image on the print medium relatively transported by the transporting unit to generate scanned image data;
selecting reference image data to be used in comparison with the scanned image data from the plural pieces of reference image data; and
detecting a failing nozzle from the plurality of nozzles based on the comparison of the scanned image data with the selected reference image data.

8. A computer readable medium recording a computer program allowing a computer to achieve:
a transporting function of controlling a transporting mechanism to relatively transport a print medium on which an image represented by image data is printed with a printing head having a plurality of nozzles in a transporting direction;
a reference image generating function of generating plural pieces of reference image data with pixel positions along the transporting direction respectively shifted by different offsets based on the image data;
a scanning function of scanning an image on the print medium relatively transported by the transporting unit to generate scanned image data;
a selecting function of selecting reference image data to be used in comparison with the scanned image data from the plural pieces of reference image data; and
a detecting function of detecting a failing nozzle from the plurality of nozzles based on the comparison of the scanned image data with the selected reference image data.
